(19) United States
(12) Patent Application Publication
(10) Pub. No.: US 2010/0258130 A1
(43) Pub. Date: Oct. 14, 2010

(54) Kitchen Mask

(76) Inventor: Kun-Chen Wu, Wufeng Shiang (TW)

Correspondence Address: Wang Law Firm, Inc., 4989 Peachtree Parkway,, Suite 200, Norcross, GA, 30092, US

(21) Appl. No.: 12/423,052

(22) Filed: Apr. 14, 2009

(51) Int. Cl. A62B 18/08; A62B 18/02

(52) U.S. Cl. 128/206.13; 128/206.28

(57) ABSTRACT

A kitchen mask includes a cover body provided for covering a mouth/nose position of a user's face, a strap disposed separately on both sides of the cover body and installed at the user's ears, and a nose portion disposed on the cover body and corresponding to the user's nose, and matched with the user's nasal profile, such that when the kitchen mask is worn, the nose portion is protruded out from the cover body, and at least one air hole disposed at the nose portion and corresponding to a position of the user's nostril, and having a thin ventilating filter material disposed at the air hole of the nose portion.

### BACKGROUND OF THE INVENTION

1. Field of the Invention

The present invention relates to a mask, in particular to a mask worn by a user for cooking food in a kitchen.

2. Description of the Related Art

As refined and delicious dining culture is our new pursuing object, we are fastidious about the diversity of food materials, and exquisite cooking skills can give rise to further food temptations. In addition, good dining designs and elegant decorations can create a romantic dining atmosphere

To make refined and delicious food more appealing, safer and more sanitary, restaurant personnel usually wear a kitchen mask when they cook, so that the restaurant personnel can sense the smell of food, while making the refined and delicious food safer and more sanitary.

In general, a mask is worn to prevent the wearer from inhaling dusts and polluted air, but the kitchen mask used for cooking is to prevent contaminants such as a cook's saliva, sweat, and nasal secretion from falling into the food.

Although the aforementioned kitchen mask can block the contaminants when the cook is cooking, the mask also affects the cook's sense of smell for the determination of a smell of the cooked food.

To overcome the aforementioned issue of the conventional mask, manufacturers produced a kitchen mask as shown in FIG. 6, and such conventional kitchen mask includes a cover body 90 and a cotton gauze 91 disposed at a nose portion of the cover body 90 to form an overall planar mask structure, and the ventilation property of the gauze 91 allows the cook to determine the smell of the cooked food.

In an application of the conventional kitchen mask as shown in FIG. 7, the portion of the gauze 91 is not aligned precisely with the inhaling position of a nostril, since the nostrils are disposed downward, so that a portion of the smell of the cooked food is absorbed by the ventilating structure of the cover body 90, or entered into a gap formed between the edge of the cover body 90 and the cook's face (as indicated by the gap A formed between the cover body 90 and the cook's nose girder as shown in FIG. 9) and absorbed by the gauze 91, before the smell of the cooked food enters into the cook's nose, and thus it is difficult for the cook to determine the quality and quantity of the smell of the cooked food.

Furthermore, the planar structure of the cover body 90 usually causes the cover body 90 to slide down from a wearer's face. In other words, the mask is supported by the wearer's nose, and thus the cover body 90 may slide downward easily when the wearer is talking or chewing. Even worse, the wearer's mouth is exposed, and thus the originally intended function of the mask no longer exists.

Therefore, it is a major point of the present invention to overcome the shortcomings of the conventional kitchen mask.

### SUMMARY OF THE INVENTION

It is a primary objective of the present invention to provide a kitchen mask for preventing foreign substances including saliva, sweat and nasal secretion from falling into food.

Another objective of the present invention is to provide a kitchen mask, such that when a cook wears the kitchen mask, the mask can be fixed at the cook's face by a nose portion corresponding to a nasal profile of the cook's nose.

To achieve the foregoing objectives, the present invention comprises: a cover body, provided for a user to cover a mouth/nose position of a face of the user; a strap, disposed separately on both sides of the cover body, and installed onto two ears; a nose portion, disposed on the cover body and corresponding to a nose portion, and being matched with a nasal profile such that the nose portion is protruded out from the cover body when the kitchen mask is worn; and at least one air hole, disposed at the nose portion and corresponding to a nostril position, and having a thin ventilating filter material disposed at the air hole of the nose portion.

The abovementioned and other objects and advantages of the present invention will be apparent with the detailed description of the following preferred embodiments with accompanying drawings.

Of course, the elements of the present invention and the arrangement of the elements may vary, but the preferred embodiments used in this specification are provided for the purpose of illustrating the structure of the invention.

### BRIEF DESCRIPTION OF THE DRAWINGS

FIG. 1 is a perspective view of a first preferred embodiment of the present invention;

FIG. 2 is a cross-sectional view of a first preferred embodiment of the present invention;

FIG. 3 is a schematic view of using a first preferred embodiment of the present invention;

FIG. 4 is an exploded view of a second preferred embodiment of the present invention;

FIG. 5 is a cross-sectional view of a second preferred embodiment of the present invention;

FIG. 6 is a schematic view of wearing a conventional mask; and

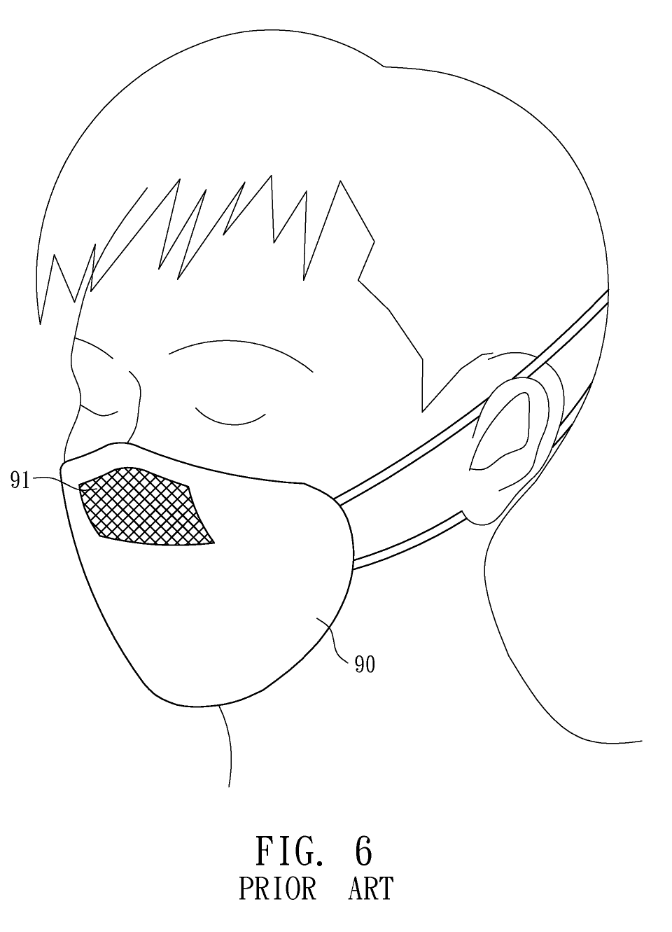

FIG. 7 is a side view of wearing a conventional mask.

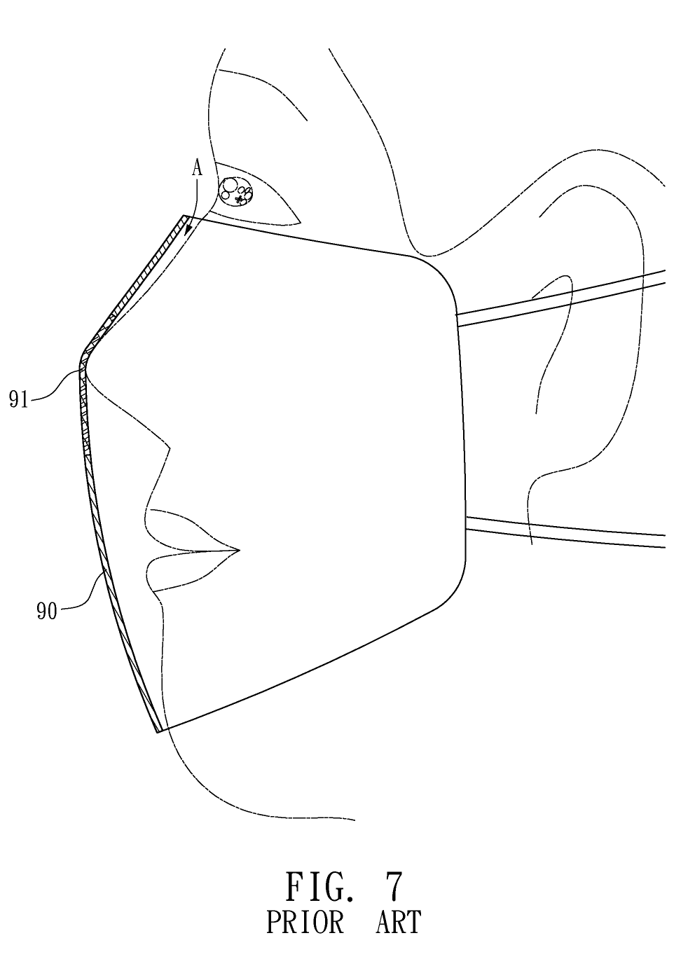

### DETAILED DESCRIPTION OF THE PREFERRED EMBODIMENTS

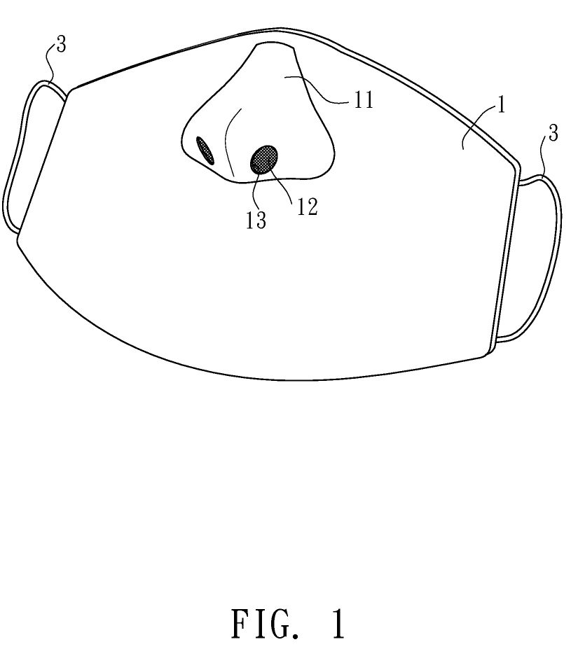

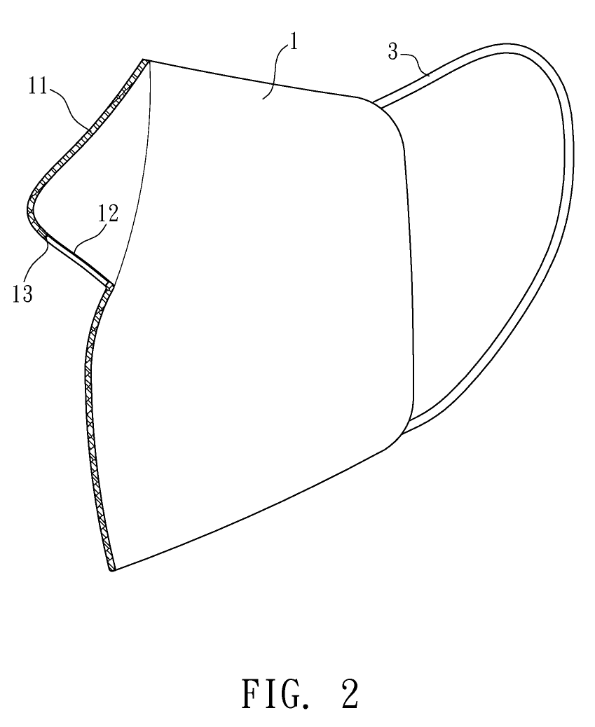

With reference to FIGS. 1 to 5 for a preferred embodiment of the present invention, this embodiment is used for illustrating the present invention, but not intended for limiting the scope of the invention.

In FIGS. 1 to 3, the kitchen mask of this preferred embodiment comprises:

a cover body 1, provided for a user to cover onto a mouth/nose position of the user's face; a strap 3 disposed separately on both sides of the cover body 1 and installed to the user's ears; a nose portion 11 disposed at the cover body 1 and corresponding to the user's nose 2, and matched with the user's nasal profile, such that when the kitchen mask is worn, the nose portion 11 is protruded out from the cover body 1; and at least one air hole 13 disposed at the nose portion 11 and corresponding to the user's nostril 21, and having a thin ventilating filter material 12 disposed at the air hole 13 of the nose portion 11.

In this preferred embodiment, the cover body 1, the nose portion 11 and the filter material 12 are integrally formed. The nose portion 11 can be a structure of a fixed shape (which is made of a plastic material or other fixed shaped material), so that the protruded nose structure can be formed directly onto the cover body 1, or the nose portion 11 can be a deformable structure, such that the nose portion 11 is supported by the nose 2 to become a protruded nose structure (wherein the nose portion 11 is made of a soft sweat-absorbing fabric and supported by the wearer's nose), when the kitchen mask is worn.

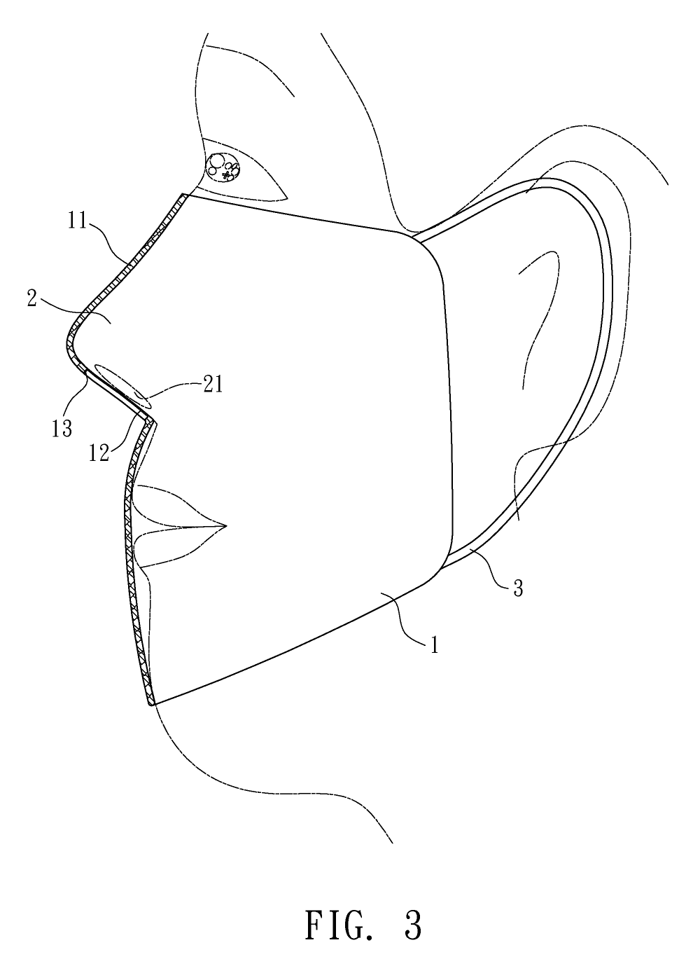

With reference to FIG. 3 for the kitchen mask of the present invention, the air hole 13 of the nose portion 11 is aligned with the nostril 21 of the nose 2, such that when the wearer is breathing, outside air will be inhaled through the air hole 13. To prevent any nasal secretion from flowing out, a filter material 12 with a ventilation property is installed at the position of the air hole 13 of the nose portion 11, and the filter material 12 comes with a thickness without affecting the wearer's determination of a smell.

Therefore, the smell of the cooked food can be inhaled through the air hole 13 by the wearer of the kitchen mask of the present invention, so that the invention can prevent the smell from being absorbed by other portions of the cover body 1 and provide a better accuracy of determining the smell than the conventional mask.

Since the nose portion 11 is a structure matched with the wearer's nasal profile, the cover body 1 situated at the internal side of the nose portion 11 and corresponding to the nose girder is attached closely to the wearer's nose girder to prevent the whole mask from sliding down, regardless of the fixed shaped structure, or the deformable structure supported by the wearer's nose 2. As a result, the mask can be fixed at any desired covered position on the face.

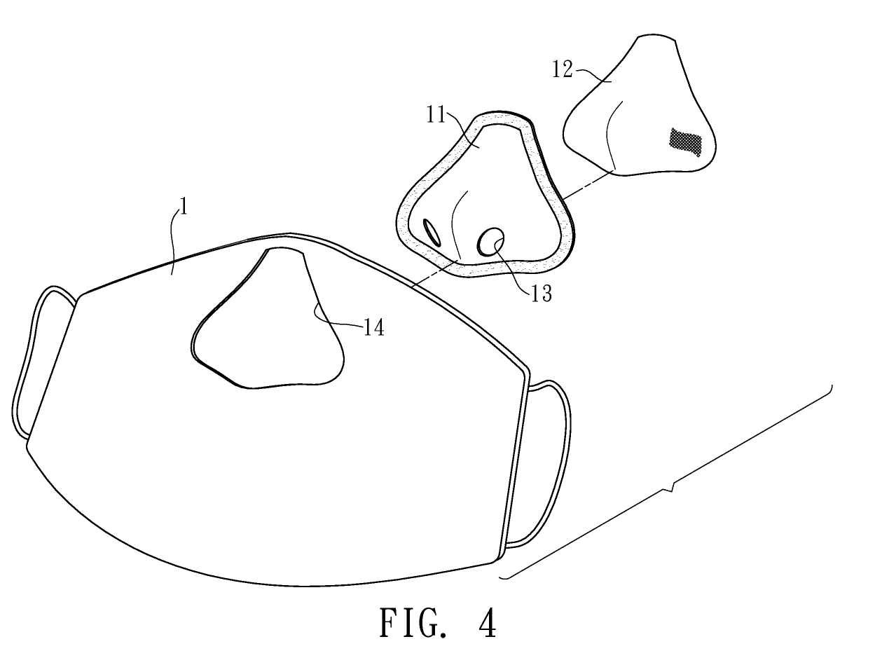

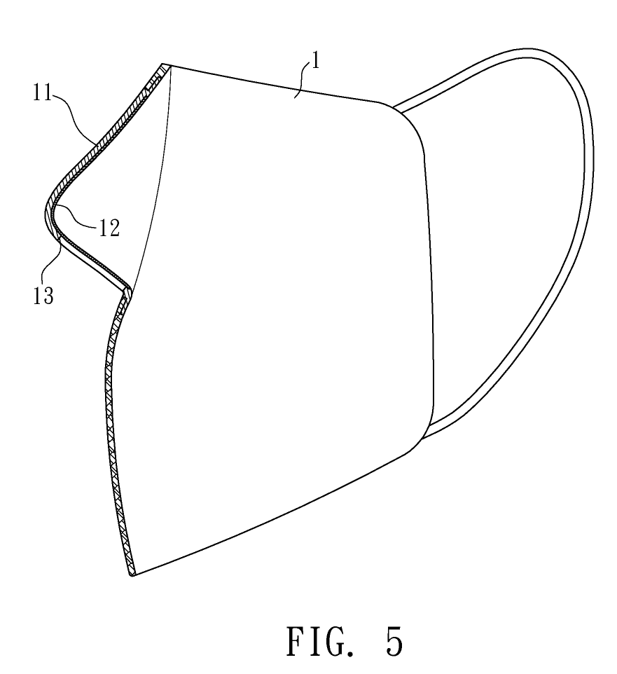

Of course, there are many other embodiments of the present invention, but their difference is minor. With reference to FIGS. 4 and 5 for a second preferred embodiment of the present invention, the nose portion 11 can be removed from the cover body 1, and the filter material 12 can be removed and replaced at the nose portion 11.

In this preferred embodiment, the cover body 1 includes a hole 14 disposed at a position corresponding to the nose 2, and the nose portion 11 is passed into the hole 14 and coupled to the cover body 1 by a Velcro tape, an adhesive or any other equivalent coupling structure. The filter material 12 is installed at the air hole 13 of the nose portion 11. In this preferred embodiment, the filter material 12 is coupled with the nose portion 11 to match the internal side of the nasal profile of the nose portion 11 and prevent foreign substances from falling out from the air hole 3.

In this preferred embodiment, the nose portion 11 and the filter material 12 can be removed and replaced with respect to the cover body 1, so that when the nose portion 11 or the filter material 12 is dirty, either the nose portion 11 or the filter material 12 can be removed and replaced independently for a continuous use, so as to save material costs and provide a convenient use.

Of course, there are other structures of the mask of the present invention. For example, the cover body 1 and the nose portion 11 are integrally formed, and the filter material 12 can be removed and replaced with respect to the nose portion 11, or the nose portion 11 and the cover body 1 can be detachable structures, and the nose portion 11 and the filter material 12 are fixed and coupled with each other.

In summation of the description above, the kitchen mask of the present invention improves over the traditional planar mask by adding the stylish nose portion 11 to achieve the effect of maintaining the sensitivity of sensing smells and the smooth breathing of restaurant personnel, and preventing foreign substances falling into a delicious dish, so as to assure a safe and sanitary cooking process of the refined and delicious food.

While the invention has been described by means of specific embodiments, numerous modifications and variations could be made thereto by those skilled in the art without departing from the scope and spirit of the invention set forth in the claims. In summation of the description above, the present invention improves over the prior art, and complies with the patent application requirements, and thus is duly file for patent application.

What is claimed is:

1. A kitchen mask, comprising:
a cover body, provided for a user to cover a mouth/nose position of a face of the user;
a strap, disposed separately on both sides of the cover body, and installed onto two ears;
a nose portion, disposed on the cover body and corresponding to a nose portion, and being matched with a nasal profile such that the nose portion is protruded out from the cover body when the kitchen mask is worn; and
at least one air hole, disposed at the nose portion and corresponding to a nostril position, and having a thin ventilating filter material disposed at the air hole of the nose portion.

2. The kitchen mask of claim 1, wherein the nose portion is a fixed nose structure protruded out from the cover body.

3. The kitchen mask of claim 1, wherein the nose portion is a deformable structure, and the nose portion is supported by the user's nose and protruded out from the nose structure, when the kitchen mask is worn.

4. The kitchen mask of claim 1, wherein the cover body, the nose portion and the filter material are integrally formed.

5. The kitchen mask of claim 1, wherein the nose portion and the cover body are integrally formed, and the filter material can be removed and replaced with respect to the nose portion.

6. The kitchen mask of claim 1, wherein the nose portion can be removed and replaced with respect to the cover body.

7. The kitchen mask of claim 6, wherein the filter material is fixed onto an internal side of the nose portion.

8. The kitchen mask of claim 6, wherein the filter material can be removed and replaced with respect to the nose portion.

9. The kitchen mask of claim 6, wherein the cover body includes a hole disposed at the nose portion, and the nose portion is passed into the hole and coupled to the cover body.
